(19) United States
(12) Patent Application Publication
(10) Pub. No.: US 2025/0026311 A1
(43) Pub. Date: Jan. 23, 2025

(54) SECURING COMMUNICATION REQUESTS FROM A VEHICLE COMMUNICATION INTERFACE TO A VEHICLE

(71) Applicant: Volvo Truck Corporation, Göteborg (SE)

(72) Inventors: Darus Pastorello, Västra Frölunda (SE); Julien Maitre, Chuzelles (FR)

(21) Appl. No.: 18/768,199

(22) Filed: Jul. 10, 2024

(30) Foreign Application Priority Data
Jul. 20, 2023 (EP) 23186589.0

(51) Int. Cl. B60R 25/30; B60R 25/24

(52) U.S. Cl. CPC B60R 25/307; B60R 25/246; B60R 2325/108

(57) ABSTRACT

Securing communication requests from a vehicle communication interface to a vehicle. In an exemplary aspect, a vehicle communication interface (VCI) device that is configured to be connected to a vehicle communication port is configured to support secure communications with a vehicle electronic control unit (ECU), such as in a standalone mode. The VCI device is configured to receive a security feature(s) from a connected diagnostic tool to then have secure access to the vehicle ECU when the diagnostic tool is disconnected from the VCI device. In this manner, the VCI device is configured to mimic secure diagnostic behavior of the diagnostic tool and leverage the pre-existing diagnostic infrastructure to securely communicate with the vehicle ECU. This prevents or mitigates unauthorized VCI-like devices from being able to be connected to a vehicle's communication port and obtain vehicle data or provide vehicle programming in an unauthorized manner.

### PRIORITY APPLICATIONS

The present application claims priority to European Patent Application No. 23186589.0, filed on Jul. 20, 2023, and entitled “SECURING COMMUNICATION REQUESTS FROM A VEHICLE COMMUNICATION INTERFACE TO A VEHICLE,” which is incorporated herein by reference in its entirety.

### TECHNICAL FIELD

The disclosure relates generally to vehicle communication interface equipment that enables communication between a vehicle and external equipment to retrieve vehicle data, including diagnostic data. In particular aspects, the disclosure relates to securing communication request from a vehicle communication interface (VCI) device to a vehicle.

The disclosure can be applied in heavy-duty vehicles, such as trucks, buses, and construction equipment. Although the aspects will be described with respect to a particular vehicle, the disclosure is not restricted to any particular vehicle or type of vehicle.

### BACKGROUND

With the increasing complexity of modern vehicles, the ability to communicate with a vehicle's onboard computer system has become vital for diagnosing and repairing issues efficiently. In this regard, a vehicle communication interface (VCI) electronic device (“VCI device”) can be provided to communicate with a vehicle's onboard computer system. For example, a VCI device can be configured to communicate with the vehicle's onboard computer system to retrieve vehicle data such as diagnostic trouble codes (DTCs), which can indicate a problem with a vehicle's electronic control modules (ECMs), sensors, or other components. A VCI can also be used to retrieve real-time vehicle data, such as engine speed, temperature, and fuel consumption. One example of a VCI device is an onboard diagnostic (OBD) reader device that can be connected to an onboard diagnostic (OBD) connector (i.e., port) present in all vehicles to be able to request vehicle data from a vehicle's onboard computer. An OBD reader device is configured to communicate information to the vehicle's onboard computer through its connection to the OBD connector according to a communication protocol (e.g., ISO 9141, controller area network (CAN) bus, etc.).

While some VCI devices may be configured as a standalone device with a user interface that can display vehicle codes from the vehicle's onboard computer to a user, many VCI devices are configured to provide a communication interface between the vehicle's onboard computer system and a connected external diagnostic tool. In this instance, the diagnostic tool is a computing device that is either connected wired or wirelessly to the VCI device to be able to communicate with the vehicle's onboard computer through the VCI device. In this regard, the VCI device provides a gateway communication device between the vehicle's onboard computer and the diagnostic tool.

### SUMMARY

Exemplary aspects disclosed herein include securing communication requests from a vehicle communication interface to a vehicle. In an exemplary aspect, a vehicle communication interface (VCI) electronic device (“VCI device”) is provided that is an electronic device configured to be connected (e.g., wired or wirelessly) to a vehicle communication port (e.g., an onboard diagnostic (OBD) port). The VCI device is configured to receive vehicle data (e.g., diagnostic trouble codes (DTCs) and real-time vehicle data, such as engine speed, temperature, and fuel consumption) through the vehicle communication port. The VCI device is a communication gateway that when connected to a vehicle communication port, is configured to propagate communications between an onboard vehicle computer (also referred to as an “electronic control unit” (ECU)) in the vehicle and a diagnostic tool communicatively coupled (wired or wirelessly) to the VCI device. In this manner, the diagnostic tool can request vehicle data through the VCI device from the vehicle's ECU. To prevent unauthorized communications between an unauthorized diagnostic tool and the vehicle, the diagnostic tool includes a diagnostic security feature(s) (e.g., a secure access protocol) to provide secure access to the vehicle ECU. In exemplary aspects, to also provide for the VCI device to support secure communication requests with the vehicle ECU (e.g., in a standalone communication mode), the VCI device is also configured to receive the security feature(s) from the diagnostic tool to then have secure access to the vehicle ECU, such as when the diagnostic tool is disconnected from the VCI device, for example. The diagnostic tool is configured to facilitate authorizing the VCI device to provide the security feature(s) to the VCI device when the diagnostic tool is coupled to the VCI device.

In this manner, by the VCI device being able to be authenticated through the diagnostic tool to receive the security feature(s) necessary for the VCI device to communicate secure requests to the vehicle ECU, this prevents or mitigates unauthorized VCI-like devices from being able to communicate requests to the vehicle ECU in an unauthorized manner. Also, by the VCI device being able to be authenticated through the diagnostic tool to receive the security feature(s) for secure communications to a connected vehicle ECU, the VCI device can mimic the secure diagnostic behavior of the diagnostic tool by leveraging the pre-existing diagnostic infrastructure to communicate with the vehicle ECU in a secure manner. In this manner, this flexibility in the VCI device being able to receive the security feature(s) through the diagnostic tool allows the VCI device to have secure communications with the vehicle ECU without the VCI device having to be vehicle ECU manufacturer specific, and without the vehicle ECU having to be altered to provide specialized security features specific to the VCI device manufacturer.

As a non-limiting example, it may be desired for the VCI device to have secure communication capability to a vehicle ECU in response to a diagnostic tool being disconnected from the VCI device for a period of time as a loss prevention action. The diagnostic tool being disconnected from the VCI device for a period of time may signify that a technician may have forgotten to retrieve and disconnect a VCI device connected to a vehicle communication port when finished with a diagnostic session for the vehicle. In this manner, by the VCI device being configured to have secure communication capability with the vehicle ECU, the VCI device can request that the vehicle ECU report an unconnected state of the VCI device to another system accessible by the vehicle ECU to be reported to a technician, workshop, and/or other system. In other words, the connection between the VCI device and the vehicle ECU can be used by the VCI device to report its unconnected state to other systems through communication to the vehicle ECU, but in a manner that prevents or mitigates unauthorized VCI-like devices from being able to request unauthorized actions to the vehicle ECU.

In another exemplary aspect, to provide for the VCI device to support secure communications with the vehicle ECU, the VCI device is configured to store a secure access protocol (as a security feature) and an ECU key (e.g., an ECU public key) in a security circuit associated with the VCI device (e.g., a hardware security module (HSM) with tamper-proof measures). For example, the secure access protocol can be a security algorithm that is programmed into the diagnostic tool to provide secure communication to the ECU. In an example, the secure access protocol and ECU key are obtained by the VCI device from an authorized ECU agent (e.g., a vehicle manufacturer for the ECU) through the diagnostic tool as part of an initialization process, when the diagnostic tool was connected to the VCI device and the diagnostic tool had established secure communications to the authorized ECU agent. As a condition to the VCI device receiving the secure access protocol and the ECU key, the diagnostic tool previously received identification information for the VCI device (“VCI device identification”) from the VCI device in a secure manner that was communicated by the diagnostic tool to the ECU agent to verify the VCI device as an authorized device. As an example, the VCI device may have been pre-authorized in a registration process with the ECU agent based on a trusted manufacturer of the VCI device providing the VCI device identification to the authorized ECU agent. Thus later, when the VCI device desires to establish a communication session with a connected vehicle ECU, such as in a standalone mode, the VCI device sends a request to the vehicle ECU. The vehicle ECU sends back a security challenge (e.g., a random number seed) to the VCI device. The security circuit in the VCI device generates an encrypted security access key-based security challenge, the ECU key, and the secure access protocol. This encrypted security access key is then communicated by the VCI device to the vehicle ECU. The vehicle ECU can then authenticate the VCI device by decrypting the encrypted security access key using a key paired with its ECU key (i.e., in a public/private key pair). In response to the vehicle ECU authenticating the VCI device based on the decrypted VCI security access key, the vehicle ECU can then authorize further communications in a communication session with the VCI device as an authorized VCI device.

According to a first aspect of the disclosure, a VCI device is provided. The VCI device comprises a security circuit comprising a secure memory. The VCI device also comprises a processing circuit communicatively coupled to the security circuit. The processing circuit is configured to receive a secure access protocol and an encrypted ECU key from a diagnostic tool, send a diagnostic request to a vehicle ECU, receive a security challenge from the vehicle ECU in response to the diagnostic request, and in response to receiving the security challenge, request the security circuit to decrypt the encrypted ECU key into a decrypted ECU key and generate a security challenge response based on the decrypted ECU key and the secure access protocol, and send the security challenge response to the vehicle ECU.

Optionally in some examples, including in at least one preferred example, the security circuit is configured to decrypt the encrypted ECU key based on the encrypted ECU key; and generate the security challenge response based on the decrypted ECU key and the secure access protocol.

Optionally in some examples, including in at least one preferred example, the processing circuitry is further configured to receive a second security challenge response from the vehicle ECU in response to sending the security challenge response to the vehicle ECU; and in response to the second security challenge response indicating authentication of the VCI device, send a second diagnostic request based on the diagnostic request to the vehicle ECU.

Optionally in some examples, including in at least one preferred example, the processing circuitry is further configured to detect if the diagnostic tool is not connected to the VCI device, and in response to detecting the diagnostic tool is not connected to the VCI device, send the diagnostic request to a vehicle ECU.

Optionally in some examples, including in at least one preferred example, the diagnostic command comprises a VCI device loss prevention command.

Optionally in some examples, including in at least one preferred example, the processing circuitry is further configured to receive a VCI device identification signature request from the diagnostic tool, and in response to receiving the VCI device identification signature request, request the security circuit to sign a VCI device identification for the VCI device based on a VCI endorsement key.

Optionally in some examples, including in at least one preferred example, the VCI device identification comprises a unique serial number of the VCI device.

Optionally in some examples, including in at least one preferred example, the processing circuitry is further configured to receive a request from the diagnostic tool to store the encrypted ECU key, and in response to receiving the request to store the encrypted ECU key, store the encrypted ECU key in a memory accessible by the processing circuitry.

Optionally in some examples, including in at least one preferred example, the processing circuitry is further configured to receive a request from the diagnostic tool to store the secure access protocol after receiving the request to store the encrypted ECU key, and in response to receiving the request to store the secure access protocol, store the secure access protocol in the memory.

Optionally in some examples, including in at least one preferred example, the processing circuitry is configured to receive the security challenge comprising a seed from the vehicle ECU in response to sending the diagnostic request to the vehicle ECU, and in response to receiving the security challenge, request the security circuit to generate the security challenge response based on the seed, the decrypted ECU key, and the secure access protocol.

Optionally in some examples, including in at least one preferred example, the processing circuitry is further configured to establish a communication session with the diagnostic tool connected to the VCI device, the processing circuitry configured to receive the secure access protocol and the encrypted ECU key in the communication session.

Optionally in some examples, including in at least one preferred example, the VCI device also includes a vehicle connector configured to be connected to a vehicle communication port communicatively coupled to the vehicle ECU, wherein the processing circuitry is communicatively coupled to the vehicle connector, and the processing circuitry is configured to send the diagnostic request through the vehicle connector to the vehicle ECU, receive the security challenge through the vehicle connector from the vehicle ECU in response to the diagnostic request; and send the security challenge response through the vehicle connector to the vehicle ECU.

According to a second aspect of the disclosure, a computer-implemented method of authorizing a vehicle communication interface (VCI) device with a vehicle electronic control unit (ECU) to allow for the VCI device to provide secure requests to the vehicle ECU is provided. The method comprises the VCI device receiving a secure access protocol and an encrypted ECU key from a diagnostic tool, sending a diagnostic request to the vehicle ECU, receiving a security challenge from the vehicle ECU in response to the diagnostic request, and in response to receiving the security challenge, decrypting the encrypted ECU key into a decrypted ECU key, generating a security challenge response based on the decrypted ECU key and the secure access protocol, and sending the security access response to the vehicle ECU.

Optionally in some examples, including in at least one preferred example, the method further comprises receiving a second security challenge from the vehicle ECU in response to sending the security challenge to the vehicle ECU, and sending a second diagnostic request based on the first diagnostic request to the vehicle ECU in response to the second security challenge response indicating authentication of the VCI device.

Optionally in some examples, including in at least one preferred example, the method further comprises detecting if the diagnostic tool is not connected to the VCI device, and in response to detecting the diagnostic tool not connected to the VCI device, sending the diagnostic request to a vehicle ECU.

Optionally in some examples, including in at least one preferred example, the method further comprises receiving a VCI device identification signature request from the diagnostic tool, and requesting the security circuit to sign a VCI device identification for the VCI device based on a VCI endorsement key, in response to receiving the VCI device identification signature request.

Optionally in some examples, including in at least one preferred example, the method comprises receiving the security challenge comprising receiving a seed from the vehicle ECU, in response to sending the diagnostic request to the vehicle ECU; and requesting the security circuit to generate the security challenge response based on the seed, the decrypted ECU key, and the secure access protocol, in response to receiving the security challenge response.

According to a third aspect of the disclosure, a computer program product comprises program code for performing, when executed by the processing circuitry, any of the aforementioned methods.

According to a fourth aspect of the disclosure, a non-transitory computer-readable storage medium comprises instructions, which, when executed by the processing circuitry, cause the processing circuitry to perform any of the aforementioned methods.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, processing circuitry, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is an exemplary vehicle that has an onboard electronic control unit (ECU) configured to control certain operations of the vehicle and to communicate vehicle data to a vehicle communication port (e.g., an onboard diagnostic (OBD) port) to be received by a connected vehicle communication interface (VCI) device;

FIG. 2 is a diagram of a VCI device connected to the vehicle communication port in FIG. 1, wherein the VCI device is configured to be wired or wirelessly coupled to a connected external diagnostic tool such that the diagnostic tool can make secure requests to the vehicle ECU through the VCI device connected to the vehicle communication port;

FIG. 3 is a schematic diagram of an exemplary VCI device that includes communication interfaces configured to be coupled to a vehicle communication port and diagnostic tool, a security circuit configured to securely store a security feature(s) to support secured access to a vehicle ECU, and a processing circuitry configured to execute software to initialize the VCI device as an authenticated secured device to enable secure communications with the vehicle ECU;

FIG. 4A is a flowchart illustrating an exemplary process of initializing the VCI device to receive a security feature(s) from a connected diagnostic tool to allow the VCI device to mimic a diagnostic tool to allow secure communications with the vehicle ECU;

FIG. 4B is a flowchart illustrating an exemplary communication process of a VCI device communicating with a vehicle ECU in a secure manner such that the vehicle ECU can authenticate the VCI device as an authorized device to provide requests to the vehicle ECU;

FIG. 5 is an exemplary communication flow/process illustrating an exemplary VCI device registration process with an authorized ECU agent, such as the vehicle manufacturer of the vehicle ECU;

FIG. 6 is an exemplary communication flow/process illustrating an exemplary configuration process to configure lists of VCI devices belonging to vehicle workshops;

FIG. 7 is an exemplary communication flow/process illustrating an exemplary VCI device discovery process performed by a diagnostic tool connected to a VCI device;

FIGS. 8A and 8B are an exemplary communication flow/process illustrating another exemplary process of initializing the VCI device to receive a security feature in the form of a secure access protocol and ECU key from a connected diagnostic tool to allow the VCI device to mimic a diagnostic tool to allow secure communications with a vehicle ECU;

FIG. 9 is an exemplary communication flow/process for a normal diagnostic session between the diagnostic tool and the vehicle ECU using the VCI device as an intermediary device;

FIG. 10 is an exemplary communication flow/process illustrating another exemplary communication process of a VCI device directly communicating requests (e.g., diagnostic requests) with a connected vehicle, such that the vehicle ECU can authenticate the VCI device and then provide responses to the VCI device in response to such requests if authenticated; and

FIG. 11 is a block diagram of an exemplary computer system that can be included in a VCI device, including but not limited to the VCI device in FIGS. 2 and 3, to securely store a security feature(s) to support secured access to a vehicle ECU, and initialize the VCI device as an authenticated secured device to permit communications with the vehicle ECU.

### DETAILED DESCRIPTION

The detailed description set forth below provides information and examples of the disclosed technology with sufficient detail to enable those skilled in the art to practice the disclosure.

Exemplary aspects disclosed herein include securing communication requests from a vehicle communication interface to a vehicle. In an exemplary aspect, a vehicle communication interface (VCI) electronic device (“VCI device”) is provided that is an electronic device configured to be connected (e.g., wired or wirelessly) to a vehicle communication port (e.g., an onboard diagnostic (OBD) port). The VCI device is configured to receive vehicle data (e.g., diagnostic trouble codes (DTCs) and real-time vehicle data, such as engine speed, temperature, and fuel consumption) through the vehicle communication port. The VCI device is a communication gateway that when connected to a vehicle communication port, is configured to propagate communications between an onboard vehicle computer (also referred to as an “electronic control unit” (ECU)) and a diagnostic tool communicatively coupled (wired or wirelessly) to the VCI device. In this manner, the diagnostic tool can request vehicle data through the VCI device from the vehicle's ECU. To prevent unauthorized communications between an unauthorized diagnostic tool and the vehicle, the diagnostic tool includes a diagnostic security feature(s) (e.g., a secure access protocol) to provide secure access to the vehicle ECU. In exemplary aspects, to also provide for the VCI device to support secure communication requests with the vehicle ECU (e.g., in a standalone communication mode), the VCI device is also configured to receive the security feature(s) from the diagnostic tool to then have secure access to the vehicle ECU, such as when the diagnostic tool is disconnected from the VCI device, for example. The diagnostic tool is configured to facilitate authorizing the VCI device to provide the security feature(s) to the VCI device when the diagnostic tool is coupled to the VCI device.

In this manner, by the VCI device being able to be authenticated through the diagnostic tool to receive the security feature(s) necessary for the VCI device to communicate secure requests to the vehicle ECU, this prevents or mitigates unauthorized VCI-like devices from being able to communicate requests to the vehicle ECU in an unauthorized manner. Also, by the VCI device being able to be authenticated through the diagnostic tool to receive the security feature(s) for secure communications to a connected vehicle ECU, the VCI device can mimic the secure diagnostic behavior of the diagnostic tool by leveraging the pre-existing diagnostic infrastructure to communicate with the vehicle ECU in a secure manner. In this manner, this flexibility in the VCI device being able to receive the security feature(s) through the diagnostic tool allows the VCI device to have secure communications with the vehicle ECU without the VCI device having to be vehicle ECU manufacturer specific, and without the vehicle ECU having to be altered to provide specialized security features specific to the VCI device manufacturer.

As a non-limiting example, it may be desired for the VCI device to have secure communication capability to a vehicle ECU in response to a diagnostic tool being disconnected from the VCI device for a period of time as a loss prevention action. The diagnostic tool being disconnected from the VCI device for a period of time may signify that a technician may have forgotten to retrieve and disconnect a VCI device connected to a vehicle communication port when finished with a diagnostic session for the vehicle. In this manner, by the VCI device being configured to have secure communication capability with the vehicle ECU, the VCI device can request that the vehicle ECU report an unconnected state of the VCI device to another system accessible by the vehicle ECU to be reported to a technician, workshop, and/or other system. In other words, the connection between the VCI device and the vehicle ECU can be used by the VCI device to report its unconnected state to other systems through communication to the vehicle ECU, but in a manner that prevents or mitigates unauthorized VCI-like devices from being able to request unauthorized actions to the vehicle ECU.

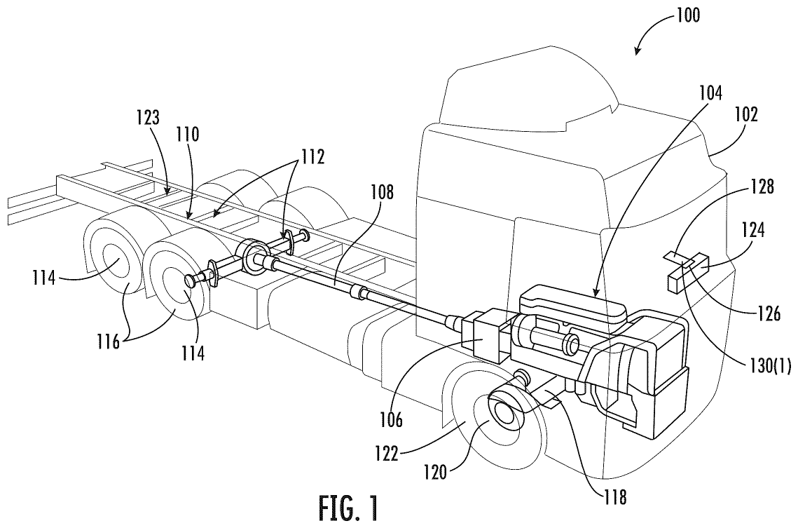

In this regard, FIG. 1 is an exemplary vehicle 100 that includes a cab 102 that houses an engine 104. The engine 104 is coupled to a gearbox 106 to couple the engine 104 to a drive shaft 108 to turn the drive shaft 108. In turn, the drive shaft 108 is coupled to a rear differential 110 that is coupled to a rear axle 112. The rotation of the drive shaft 108 will cause the power of the engine 104 to be transferred to the rear axle 112 through the rear differential 110 to rotate wheels 114 coupled to the rear axle 112, and thus rotate the rear tires 116 mounted on the wheels 114. In this example, the vehicle 100 is a truck that includes two rear axles 112 that are coupled to respective wheels 114. In this example, the vehicle 100 is also equipped to be operated in four wheel drive (4WD), wherein the drive shaft 108 will be coupled to a front axle 118 that is coupled to front wheels 120, to drive power to the front wheels 120 causing the front wheels 120 and their mounted tires 122 to rotate. The vehicle 100 may also include rear axles pumps 123 that each include, for example, a hydraulic pump, to control a lifting force applied to the respective rear axles 112 to alter the load distribution on the rear axles 112 of the vehicle 100.

With continuing reference to FIG. 1, the vehicle 100 also has an onboard computer 124, also referred to as a vehicle electronic control unit (ECU) 124. The vehicle ECU 124 is configured to control certain operations of the vehicle 100, such as the engine 104, the gearbox 106, and the rear axles 112 and front axle 118, among other components. The vehicle ECU 124 is also configured to communicate vehicle data to a vehicle communication port 126 to be received by a connected vehicle communication interface (VCI) device 128. For example, the vehicle communication port 126 can be an onboard diagnostic (OBD) port that is present in all vehicles to be able to request vehicle data from a vehicle's onboard computer, like the vehicle ECU 124. The VCI device 128 is an electronic device that has a first external VCI communication port 130(1) that is configured to be connected to the vehicle communication port 126 to exchange communication requests (e.g., to retrieve vehicle data) from the vehicle ECU 124 through its connection to the vehicle communication port 126 according to a communication protocol (e.g., ISO 9141, controller area network (CAN) bus, etc.). Examples of vehicle data that can be obtained by the VCI device 128 from the vehicle ECU 124 through the connected to the vehicle communication port 126 include, but is not limited to, diagnostic trouble codes (DTCs) and real-time vehicle data, such as engine speed, temperature, and fuel consumption). The VCI device 128 may have a display that is configured to display the vehicle data to a user or technician of the VCI device 128. Thus, for example, a technician may use the VCI device 128 to perform diagnostics on the vehicle 100 using the vehicle data received by the VCI device 128 from the vehicle ECU 124, which can then be displayed to the technician on a display on the VCI device 128.

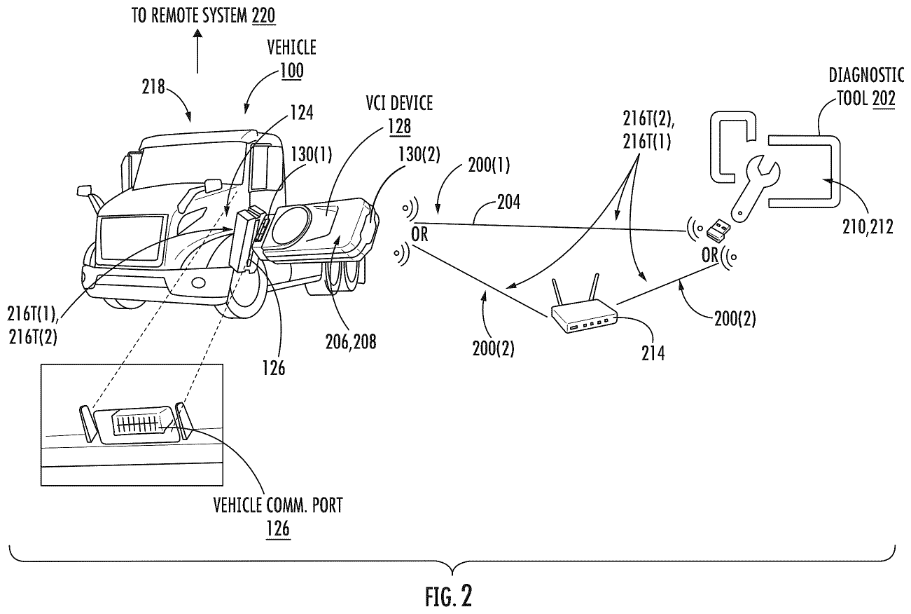

As shown in FIG. 2, the VCI device 128 may also be configured to provide a wired and/or wireless VCI communication interface 200(1), 200(2) between the vehicle ECU 124 and connected external diagnostic tool 202. The diagnostic tool 202 is a computing device that may be a personal computer, for example, and is configured to communicate secure requests to the vehicle ECU 124 through the VCI device 128. The diagnostic tool 202 can be programmed with more sophisticated functions to request vehicle data from the vehicle ECU 124 and otherwise communicate to the vehicle ECU 124 through the connection to the VCI device 128. The diagnostic tool 202 can also be programmed with security features and functions so that the diagnostic tool 202 can be used to communicate requests to the vehicle ECU 124 that can be authenticated as being from an authorized diagnostic tool for security reasons.

In this regard, the diagnostic tool 202 may be able to be connected wired to the VCI device 128 using the wired VCI communication interface 200(1) provided by a second external VCI communication port 130(2) in the VCI device 128. For example, a communication cable 204 may be provided to physically connect the second external VCI communication port 130(2) to the diagnostic tool 202. Alternatively or in addition, the diagnostic tool 202 may be able to be connected wireless to the VCI device 128 using the wireless VCI communication interface 200(2) provided via a wireless transceiver 206 provided in the VCI device 128. For example, the wireless transceiver 206 may be a Wi-Fi transceiver 208 that is configured to communicate wirelessly with the diagnostic tool 202 that has a wireless transceiver 210, such as a Wi-Fi transceiver 212. For example, a wireless access point 214 may be provided to facilitate communications between the wireless transceiver 206 of the VCI device 128 and the wireless receiver 210 of the diagnostic tool 202. In this regard, the VCI device 128 provides a gateway communication device between the vehicle ECU 124 and the diagnostic tool 202. The diagnostic tool 202 can be programmed with more sophisticated functions to transmit secure communication requests 216T(2) to the vehicle ECU 124, through the VCI device 128 as an intermediary device. This is to retrieve vehicle data and/or to request other actions or control of components in the vehicle 100 or related to the vehicle 100 through the connectivity of the vehicle ECU 124 and the diagnostic tool 202 to the VCI device 128. The vehicle ECU 124 can transmit secure communication requests 216T(1) to the diagnostic tool 202, through the VCI device 128 as an intermediary device.

As discussed in more detail below, the diagnostic tool 202 can also be programmed with security features and functions so that the diagnostic tool 202 can be used to transmit secure communication requests 216T(2) through the VCI device 128 to the vehicle ECU 124 that can be authenticated by the vehicle ECU 124 as being from an authorized diagnostic tool for security reasons. For example, as also discussed in more detail below, the vehicle ECU 124 may have the ability to communicate wirelessly through a telematics system 218 (e.g., cellular/radio communication system, satellite communication system) on the vehicle 100 that is configured to wirelessly communicate to a remote system 220 to provide communication capability between the vehicle ECU 124 and the remote system 220. As an example, the remote system 220 may be a vehicle manufacturer cloud server that is configured to not only be accessed through telematic systems of vehicles, like telematic system 218 of vehicle 100, but is also configured to be accessed by the vehicle manufacturer to access vehicle data received by vehicles as well as provide data back to the vehicles. For example, the remote system 220 may be able to remotely reconfigure or update software in the vehicle 100 that is configured to be executed by a processing circuitry, including the vehicle ECU 124.

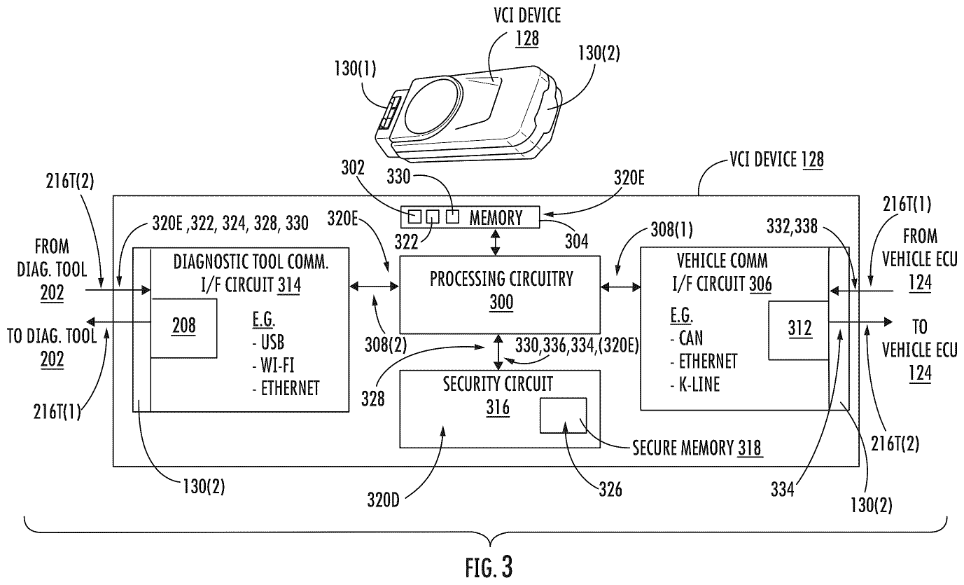

FIG. 3 is a schematic diagram of the exemplary VCI device 128 in FIGS. 1 and 2. The exemplary VCI device 128 shown in FIG. 3 includes additional exemplary detail of circuits to not only facilitate communications (in a communication session) between the diagnostic tool 202 and the vehicle ECU 124 in FIG. 2, but also to provide a mechanism for the VCI device 128 to direct secure communication requests (in a communication session) to the vehicle ECU 124 to be processed in a communication exchange between the VCI device 128 and the vehicle ECU 124. As illustrated in FIG. 3, the VCI device 128 in this example includes processing circuitry 300 configured to execute program instructions 302 (e.g., software, firmware) stored in a memory 304 to perform programmed tasks. The processing circuitry 300 can be a microprocessor, also referred to as a processor, as an example. The processing circuitry 300 could also be provided as a micro-controller or other hardware processing circuitry, such as a field-programmable gate array (FPGA).

The processing circuitry 300 is configured to interface with a vehicle communication interface circuit 306 to exchange communication requests/responses 308(1) (which may also be referred to herein as “diagnostics requests 308(1)” or “diagnostic responses 308(1)”) with the processing circuitry 300, through the first external VCI communication port 130(1) to the vehicle ECU 124, to receive/transmit communication requests 216T(1), 216T(2) from/to the vehicle ECU 124 (sec FIG. 2). For example, the vehicle communication interface circuit 306 includes a transceiver 312 in this example configured to receive/transmit communication requests 216T(1), 216T(2) from/to the vehicle ECU 124. The vehicle communication interface circuit 306 and its transceiver 312 can be configured to support any desired standard or proprietary communication wired and/or wireless protocol, such as CAN bus, Ethernet, and K-line communication protocols as examples.

With continuing reference to FIG. 3, the processing circuitry 300 in the VCI device 128 is also configured to interface with a diagnostic tool communication interface circuit 314 to exchange communication requests/responses 308(1), 308(2) with the processing circuitry 300, through the second external VCI communication port 130(2), to the diagnostic tool 202 (see also, FIG. 2). Communication requests/responses 308(2) may also be referred to herein as “diagnostic requests 308(2)” or “diagnostic responses 308(2)”. The diagnostic tool communication interface circuit 314 includes the wireless transceiver 206 in this example that is configured to transmit communication requests 216T(1) received from the vehicle ECU 124 to the diagnostic tool 202. The diagnostic tool communication interface circuit 314 is also configured to receive communication requests 216T(2) from the diagnostic tool 202 to be provided to the vehicle ECU 124. The diagnostic tool communication interface circuit 314 can be configured to support any desired standard or proprietary wired or wireless communication protocol, such as universal serial bus (USB), Wi-Fi, and Bluetooth communication protocols as examples. For example, the diagnostic tool communication interface circuit 314 may support a wired and/or wireless communication capability to the diagnostic tool 202. In this regard, note that the transceiver 206 could be a wireless and/or wired transceiver.

In this manner, as shown in FIG. 3 by example, the VCI device 128 includes circuitry and operations that allow the VCI device 128, when its second external VCI communication port 130(2) is coupled to the vehicle communication port 126, to interface with the vehicle ECU 124 to obtain vehicle data, such as diagnostic codes. Also, in this example, the VCI device 128 includes circuitry and operations that allow the VCI device 128 to also act as a communication conduit or gateway to forward or otherwise transmit communication requests 216T(2) received from the diagnostic tool 202 to the vehicle ECU 124. This is when the first external VCI communication port 130(1) of the VCI device 128 is connected to the vehicle 100 and thus communicatively coupled to the vehicle ECU 124. The diagnostic tool 202 can include security features that allow it to format or otherwise create secure communication requests 216T(2) to be transmitted to the vehicle ECU 124 that can be verified or authenticated by the vehicle ECU 124 as being authorized. For example, the diagnostic tool 202 may have private/public encryption capability that uses a private key assigned to the diagnostic tool 202 to digitally sign (i.e., encrypt) secure communication requests 216(2) transmitted to the vehicle ECU 124. As discussed in more detail below, in an example, the vehicle ECU 124 can be equipped with the public key that is paired with the private key for the vehicle ECU 124 to allow the vehicle ECU 124 to authenticate (i.e., decrypt) the secure communication request 216T(2) from the diagnostic tool 202. In an example, as discussed in more detail below, the diagnostic tool 202 has the public key of the vehicle ECU 124 to be able to encrypt identification information about the VCI device 128 to send to the vehicle ECU 124 to authorize the VCI device 128. The vehicle ECU 124 uses its private key to decrypt the identification information about the VCI device 128. The vehicle ECU 124 can then determine whether the diagnostic tool 202 is authorized to provide secure communication requests 216T(2) to the vehicle ECU 124, and if so, the vehicle ECU 124 can respond with secure communication responses 216T(1) to such requests using the VCI device 128 as an intermediary device.

As discussed above, it is also desired to provide for the VCI device 128 to be able to support secure communication requests 308(1) to the vehicle ECU 124 that were generated by the VCI device 128 that are not a forwarding of received secure communication requests 216T(2) from the diagnostic tool 202. For example, it may be desired for the VCI device 128 to have direct secure communication capability to the vehicle ECU 124 in response to a previously connected diagnostic tool 202 being disconnected from the VCI device 128 for a period of time as a loss prevention action. The diagnostic tool 202 being disconnected from the VCI device 128 for a period of time may signify that a technician may have forgotten to retrieve and disconnect a VCI device 128 connected to the vehicle communication port 126 when finished with a diagnostic session for the vehicle 100. In this manner, by the VCI device 128 being configured to have secure communication capability with the vehicle ECU 124, the VCI device 128 can request that the vehicle ECU 124 report an unconnected state of the VCI device 128 to another system accessible by the vehicle ECU 124 to be reported to a technician, workshop, and/or other system. In other words, the connection between the VCI device 128 and the vehicle ECU 124 can be used by the VCI device 128 to report its unconnected state to other systems through communication to the vehicle ECU 124. However, it is desired that the VCI device 128 be able to be authorized by the vehicle ECU 124 as an authorized device to prevent or mitigate unauthorized VCI-like devices from being able to request unauthorized actions to the vehicle ECU 124.

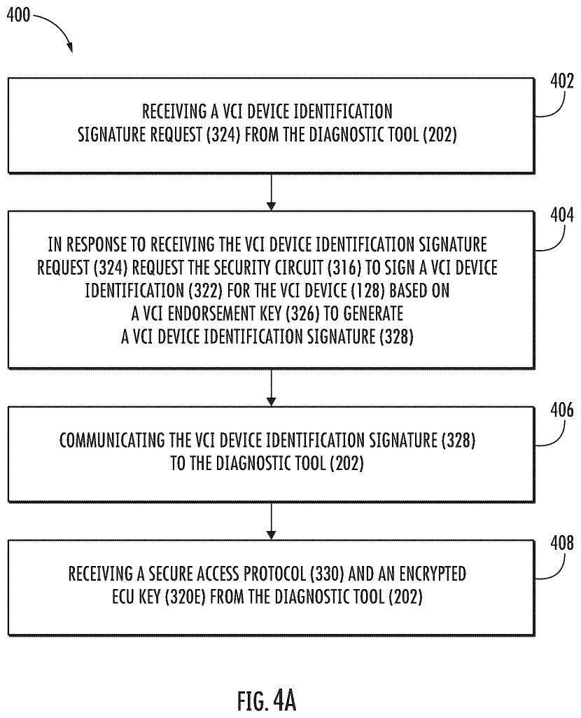

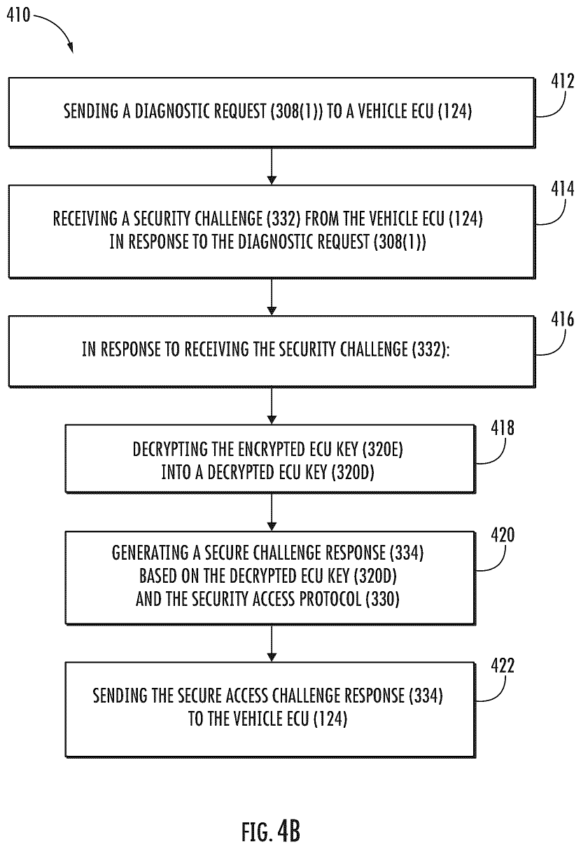

In this regard, the VCI device 128 is also capable of performing an initialization process to authorize the VCI device 128 as an authorized device to then be able to direct secure communication requests 308(1) to the vehicle ECU 124 in a manner that can be authenticated by the vehicle ECU 124. FIG. 4A is a flowchart illustrating an exemplary initialization process 400 of the diagnostic tool 202 using its connection to the VCI device 128 to authorize the VCI device 128 as being authorized to provide secure communication requests 216T(2) to the vehicle ECU 124. As discussed in more detail below, the diagnostic tool 202, as part of the initialization process, is configured to provide a secure access protocol to the VCI device 128, if authorized, to allow the VCI device 128 to mimic the diagnostic tool 202, which is an authorized device, with the vehicle ECU 124. This allows the VCI device 128 using the secure communication process 410 to provide authorized secure communication requests 216T(2) to the vehicle ECU 124, that can be authenticated by the vehicle ECU 124 as coming from an authorized device. FIG. 4B is a flowchart illustrating an exemplary secure communication process 410 of the VCI device 128 providing secure communication with the vehicle ECU 124 that can be authenticated by the VCI device 128 as authorized. The exemplary initialization process 400 and secure communication process 410 in FIGS. 4A and 4B are discussed below in conjunction with the exemplary VCI device 128 in FIG. 3.

In this regard, to facilitate secure communications between the VCI device 128 and vehicle ECU 124, in this example, the VCI device 128 in FIG. 3 includes a security circuit 316. The security circuit 316 is a secure hardware circuit that is resistant to being tampered with or hacked. The security circuit may include a secure memory 318 that can be used for storage of data within the security circuit 316 and is private to the security circuit 316 and not accessible outside the security circuit 316 for security purposes. As discussed in more detail below, the security circuit 316 is configured to be used by the processing circuitry 300 to request decryption of a received encrypted ECU public key 320E received from the diagnostic tool 202 when connected to the VCI device 128.

When the diagnostic tool 202 is connected to the VCI device 128, the diagnostic tool 202 can perform the initialization process 400 in FIG. 4A to authorize the VCI device 128 as being a device that is authorized to provide secure communication requests to the vehicle ECU 124. In this regard, the diagnostic tool 202 can communicate with the VCI device 128 to retrieve a secure version of a VCI device identification 322 identifying the VCI device 128. For example, the VCI device identification 322 may be a unique serial number of the VCI device 128. In this regard, the diagnostic tool 202 can communicate a VCI device identification signature request 324 to the VCI device 128 that is received by the VCI device 128 (block 402 in FIG. 4A). In response to the VCI device 128 receiving the VCI device identification signature request 324, the processing circuitry 300 of the VCI device 128 can request the security circuit 316 to sign the VCI device identification 322 for the VCI device 128 based on a VCI private endorsement key 326 to generate a VCI device identification signature 328 (block 404 in FIG. 4A). The VCI device 128 can then communicate the VCI device identification signature 328 to the diagnostic tool 202 (block 406 in FIG. 4A). The diagnostic tool 202 can then communicate the secure VCI device identification 322 to the remote system 220 (see FIG. 2), to authorize the VCI device 128.

As discussed below, the VCI device 128 could be registered ahead of time by the manufacturer of the VCI device 128 with the remote system 220 as an authorized device, with the remote system 220 storing a VCI public endorsement key of the VCI device 128 as part of a VCI public endorsement key/VCI private endorsement key 326 pair assigned to the VCI device 128. The security circuit 316 has secure access to the VCI private endorsement key 326 for its VCI device 128, which may be stored in the secure memory 318. If the VCI device 128 is authorized by the remote system 220, the diagnostic tool 202 can then provide a secure access protocol 330 (e.g., a messaging protocol and/or an encryption/decryption algorithm or process (e.g., SHA-256, Equihash)) and the encrypted ECU public key 320E that was encrypted by the vehicle ECU 124 using the VCI device public endorsement key (see block 408 in FIG. 4A). The processing circuitry 300 can then store the secure access protocol 330 and the encrypted ECU public key 320E in memory 304 to be used for the processing circuity 300 of the VCI device 128 to generate communication requests 308(1) securely to the vehicle ECU 124.

Then, after the VCI device 128 is authorized using the above discussed initialization process 400 through communication with a connected diagnostic tool 202, the VCI device 128 can perform the secure communication process 410 in FIG. 4B to be able to directly communicate secure communication requests 216T(2) in an authorized manner to the vehicle ECU 124. In this regard, the VCI device 128 can send a diagnostic request as a secure communication request 308(1) to the vehicle ECU 124 (block 412 in FIG. 4B). In response, the VCI device 128 receives a security challenge 332 from the vehicle ECU 124 (block 414 in FIG. 4B). In response to receiving the security challenge 332 from the vehicle ECU 124 (block 416 in FIG. 4B), the VCI device 128 is configured to execute the secure access protocol 330 previously received from the diagnostic tool 202 in the initialization process to be able to generate a security challenge response 334 to be communicated as a secure communication request 216T(2) to the vehicle ECU 124 that can be authenticated as coming from an authorized VCI device 128.

In this regard, in an example and as discussed below, the processing circuitry 300 uses a decrypted version of the ECU public key 320E to generate the security challenge response 334 to be communicated to the vehicle ECU 124 to authenticate the VCI device 128 The processing circuitry 300 provides a request 336 to the security circuit 316 in response to the VCI device 128 and the processing circuity 300 receiving a security challenge 332 as a secure communication request 216T(1) from the vehicle ECU 124 in response to the VCI device 128 providing the diagnostic request 308(1) to the vehicle ECU 124 (block 416 in FIG. 4B). The request 336 from the processing circuitry 300 is to have the security circuit 316 generate the security challenge response 334. The security circuit 316 decrypts the encrypted ECU public key 320E into a decrypted ECU public key 320D (block 418 in FIG. 4B). The security circuit 316 generates the security challenge response 334 that includes the VCI device identification 322 using the decrypted ECU public key 320D decrypted from the encrypted ECU public key 320E (block 420 in FIG. 4B). This is so that the vehicle ECU 124 can use its ECU private key to authenticate the security challenge response 334 to authorize the VCI device 128. In this manner, the decrypted ECU public key 320D is secure within the security circuit 316 for security reasons so that such cannot be hacked to allow unauthorized parties to program their VCI device to act as authorized devices. As discussed above, the encrypted ECU public key 320E was encrypted by the vehicle ECU 124 using the VCI public endorsement key for the VCI device 128. Thus, the security circuit 316 can use the VCI private endorsement key 326 to unencrypt the encrypted ECU public key 320E and generate the security challenge response 334 using the decrypted ECU public key 320D. The security circuit 316 can use the secure access protocol 330 provided from the diagnostic tool 202 in the initialization process discussed above to perform the decryption of the encrypted ECU public key 320E and then encrypt the security challenge response 334 based on the secure access protocol 330. The processing circuity 300 can then send the security challenge response 334 to the vehicle ECU 124 as a communication request 216T(2) to have the vehicle ECU 124 authorize the VCI device 128 (block 422 in FIG. 4B).

The vehicle ECU 124 can use its ECU private key associated with the ECU public key 320D to decrypt the security challenge response 334 to obtain the VCI device identification 322. The vehicle ECU 124 can then determine if the VCI device 128 is authorized as an authorized device based on the VCI device identification 322. The VCI device identification 322 of the authorized VCI device 128 was previously registered in the registration process discussed above. If authorized, the vehicle ECU 124 can issue another, second security challenge response 338 to the VCI device 128 to indicate authorization of the VCI device 128, so that the VCI device 128 can then issue its diagnostic request as a second diagnostic request to be serviced by the vehicle ECU 124.

In this manner, by the VCI device 128 being able to be authorized through the diagnostic tool 202 to receive the secure access protocol 330 necessary for the VCI device 128 to communicate secure requests to the vehicle ECU 124, this prevents or mitigates unauthorized VCI-like devices from being able to communicate requests to the vehicle ECU 124 in an unauthorized manner. Also, by the VCI device 128 being able to be authorized through communication with the diagnostic tool 202 to receive the secure access protocol 330 for secure communications to a connected vehicle ECU 124, the VCI device 128 can mimic the secure diagnostic behavior of the diagnostic tool 202 by leveraging the pre-existing diagnostic infrastructure to communicate with the vehicle ECU 124 in a secure manner. In this manner, this flexibility in the VCI device 128 being able to receive the secure access protocol 330 through the diagnostic tool 202 allows the VCI device 128 to have secure communications with the vehicle ECU 124 without the VCI device 128 having to be vehicle ECU manufacturer specific, and without the vehicle ECU 124 having to be altered to provide specialized security features specific to the manufacturer of the VCI device 128.

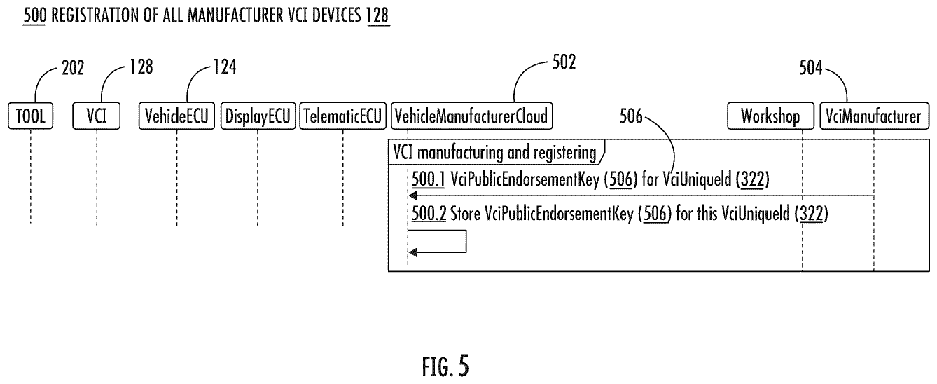

FIGS. 5-10 discussed below are additional exemplary processes with additional exemplary detail that can be performed involving the VCI device 128 being able to be authorized as part of an initialization process, through communication with the diagnostic tool 202, to perform secure communication requests to a connected vehicle ECU 124. The communication flows and processes in FIGS. 5-10 will now be discussed.

In this regard, FIG. 5 is a communication flow/process chart illustrating an exemplary VCI device 128 registration process 500 between an authorized ECU agent 502, such as the vehicle manufacturer of the vehicle ECU 124, and a VCI manufacturer 504 of a VCI device 128. For example, as discussed above, it may be desired for the VCI device 128 to be registered with an authorized ECU agent 502 of the vehicle ECU 124 so that the vehicle ECU 124 has a way to determine if a vehicle ECU 124 is authorized through a later performed initialization process by the VCI device 128 with a connected diagnostic tool 202. In this regard, in this example, a VCI manufacturer 504 of the VCI device 128 communicates the VCI device identification 322 and the VCI public endorsement key 506 (that is paired with the VCI private endorsement key 326) to the authorized ECU agent 502 (block 500.1 in FIG. 5). For example, the authorized ECU agent 502 may be provided in FIG. 5 on a server or remote location and have the capability of communication with a vehicle ECU 124. The authorized ECU agent 502 stores the VCI device identification 322 and the VCI public endorsement key 506 (block 500.2 in FIG. 5). This is so that later when a request relating to initialization of a VCI device 128 is received, the authorized ECU agent 502 can use the stored VCI device identification 322 to authorize the VCI device 128 being initialized and use the VCI public endorsement key 506 to encrypt the ECU public key 320E to be provided securely to the VCI device 128 to use to generate the security challenge response 334 and subsequent authorized communication requests 308(1) (e.g., diagnostic requests) to the vehicle ECU 124 to be serviced.

Note that certain VCI devices 128 may be associated with a particular location or vehicle workshop. Thus, it may be desired to also configure (i.e., associate) particular registered VCI devices 128, using the registration process 500 in FIG. 5 so that a diagnostic tool 202 connected to a VCI device 128 at its location or workshop can determine the VCI device 128 is associated with such location or workshop. This may be useful in authorizing connected VCI devices 128 as part of the initialization process for a connected VCI device 128, as discussed above.

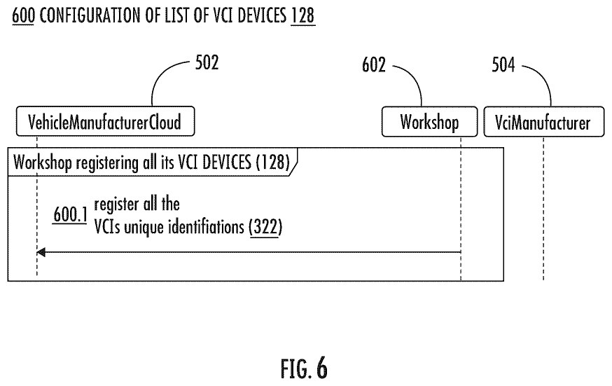

In this regard, FIG. 6 is a communication flow/process chart illustrating an exemplary configuration process 600 between a vehicle workshop 602 and the authorized ECU agent 502 to report VCI devices 128 that are authorized or expected to be used in the vehicle workshop 602. In this regard, the vehicle workshop 602 communicates the VCI device identification 322 of authorized or expected VCI devices 128 to be used in the vehicle workshop 602 to the authorized ECU agent 502 (block 600.1 in FIG. 6). This is so that later when a request relating to initialization of a VCI device 128 is received, the authorized ECU agent 502 can use the stored VCI device identification 322 to further authorize the VCI device 128 being initialized based on the vehicle workshop 602 where the diagnostic tool 202 is connected to the VCI device 128.

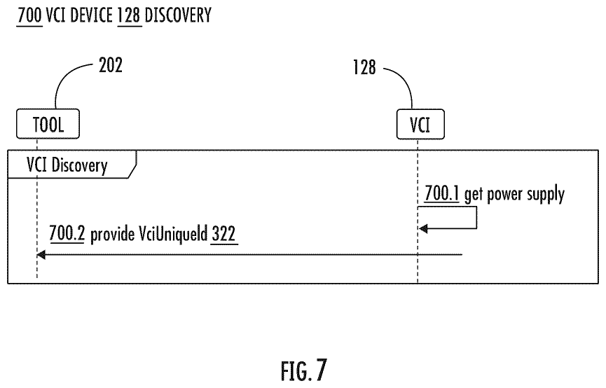

When a VCI device 128 is connected to a diagnostic tool 202 and powered on or reset, the VCI device 128 can be configured to provide its VCI device identification 322 to the diagnostic tool 202 to identify itself to the diagnostic tool 202 as part of a discovery process. In this regard, FIG. 7 is a communication flow/process illustrating an exemplary discovery process 700 between a VCI device 128 and the diagnostic tool 202 for the VCI device 128 to communicate its VCI device identification 322 to the diagnostic tool 202. In this regard, when the VCI device 128 is powered on or reset and connected to a diagnostic tool 202 (block 700.1 in FIG. 7), the VCI device 128 communicates the VCI device identification 322 to the diagnostic tool 202 (block 700.2 in FIG. 7).

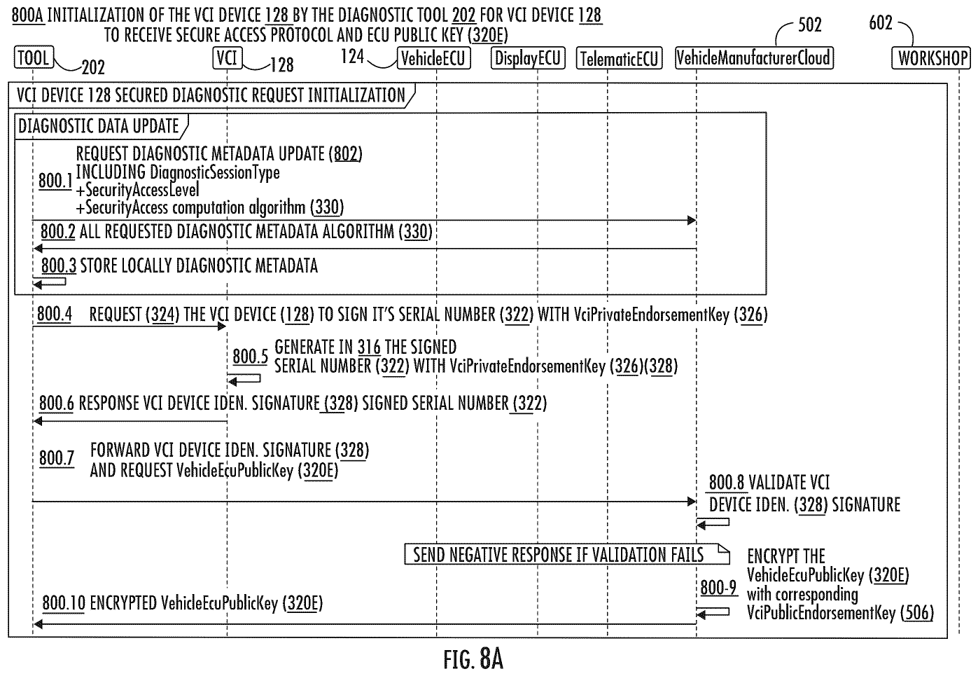

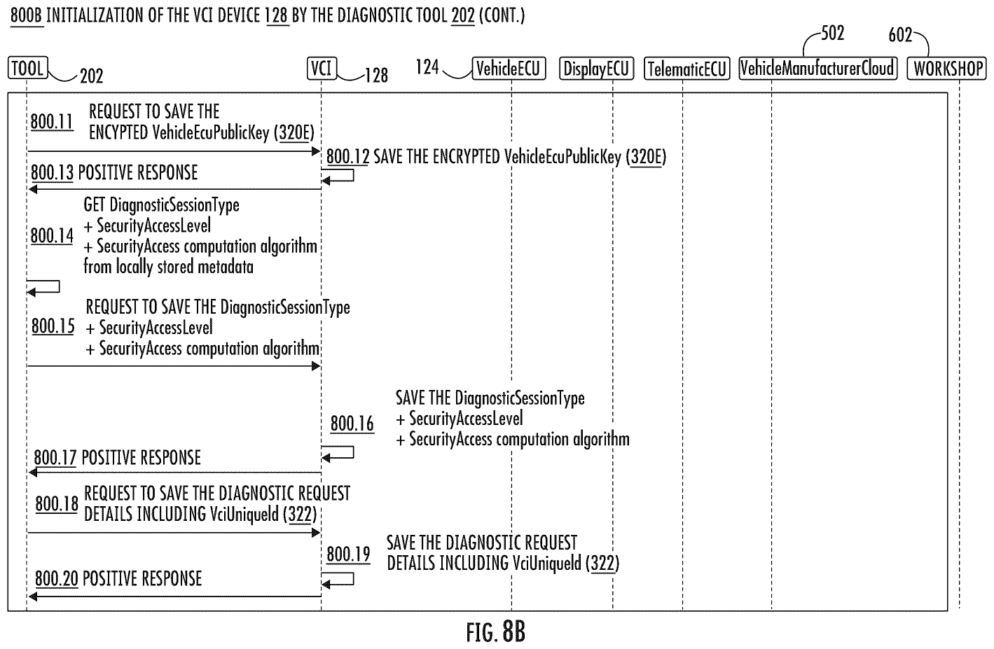

FIGS. 8A and 8B are a communication flow/process illustrating another exemplary initialization process 800 of initializing the VCI device 128 to authenticate the VCI device 128 as an authorized device to provide secure communications to the vehicle ECU 124. The initialization process 800 in FIGS. 8A and 8B is similar to the exemplary initialization process 400 in FIG. 4A, but the initialization process 800 in FIGS. 8A and 8B includes more exemplary detail.

In this regard, as illustrated in FIG. 8A, after the diagnostic tool 202 receives the VCI device identification 322 from a connected VCI device 128 (see block 700.2 in FIG. 7), the diagnostic tool 202 communicates a secure diagnostic update 802 to the authorized ECU agent 502 to perform a diagnostic update to obtain any updates to the secure access protocol 330 (block 800.1 in FIG. 8A). This is in case there have been any updates to the secure access protocol 330 since the diagnostic tool 202 last received the secure access protocol 330 to perform secure communications with the vehicle ECU 124. In this example, the secure diagnostic update 802 is communicated to retrieve all diagnostic metadata except the ECU public key 302E. The authorized ECU agent 502 provides any updates to the secure access protocol 330 (block 800.2 in FIG. 8A), which is then stored by the diagnostic tool 202 (block 800.3 in FIG. 8A), for later use in communication with the vehicle ECU 124 through the VCI device 128.

Then, to begin the initialization process of authorizing the connected VCI device 128, the diagnostic tool 202 communicates a VCI device identification signature request 324 to the VCI device 128 to request that it sign its VCI device identification 322 with its VCI private endorsement key 326 (block 800.4 in FIG. 8A). As previously discussed by example in FIG. 3, the VCI device 128 can call upon its security circuit 316 to use the securely stored VCI private endorsement key 326 to sign its VCI device identification 322 (block 800.5 in FIG. 8A). Because the VCI public endorsement key 506 was previously registered with the authorized ECU agent 502, as discussed below, the authorized ECU agent 502 will be able to authenticate the VCI device identification 322 to then indicate to the diagnostic tool 202 whether the VCI device 128 is authorized based on registered authorized VCI devices 128 based on their registered VCI device identifications 322. After the VCI device 128 generates the VCI device identification signature 328 (block 800.5 in FIG. 8A), which is then communicated by the VCI device 128 to the diagnostic tool 202 (block 800.6 in FIG. 8A). The diagnostic tool 202 then forwards the VCI device identification signature 328 to the authorized ECU agent 502 to validate the VCI device identification signature 328 (block 800.7 in FIG. 8A). The authorized ECU agent 502 validates the VCI device identification signature 328 based on the previously received and stored VCI public endorsement key 506 and VCI device identification 322 associated with the stored VCI public endorsement key 506 as part of the registration process (see registration process 500 in FIG. 5) (block 800.8 in FIG. 8A). If the VCI device identification signature 328 is validated, this means that the VCI device 128 associated with the VCI device identification 322 signed in the VCI device identification signature 328 is authorized and permitted to make secure direct communication requests to the vehicle ECU 124. In this regard, to provide the credentials back to the VCI device 128 to use to be able to securely communicate requests to the vehicle ECU 124, the authorized ECU agent 502 encrypts the vehicle ECU public key as an encrypted vehicle ECU public key 320E with the VCI public endorsement key 506 (block 800.9 in FIG. 8A), and communicates the encrypted vehicle ECU public key 320E back to the diagnostic tool 202 (block 800.10 in FIG. 8A).

Then, as shown in a continuing of the initialization process 800 in FIG. 8B, the diagnostic tool 202 sends a request to the VCI device 128 to store the encrypted ECU public key 320E (block 800.11 in FIG. 8B). The VCI device 128 stores the encrypted ECU public key 320E (block 800.12 in FIG. 8B) and provides an acknowledgement response to the diagnostic tool 202 of a successful receipt and storage of the encrypted ECU public key 320E (block 800.13 in FIG. 8B). For example, the VCI device 128 can store the encrypted ECU public key 320E in its memory 304 as previously discussed with regard to FIG. 3. The VCI device 128 will later decrypt the encrypted ECU public key 320E using its VCI private endorsement key 326 to then use such to provide secure communication requests to the vehicle ECU 124 that can be authenticated based on the VCI device 128 having had access to the decrypted ECU public key 320D. The fact that the authorized ECU agent 502 had registered access to the VCI public endorsement key 506 for the VCI device 128, that was then used to encrypt the ECU public key 302E, means that the VCI device 128 can decrypt the encrypted ECU public key 302E using its paired VCI private endorsement key 326. Also in this example, it is this knowledge of the VCI public endorsement key 506 by the authorized ECU agent 502 that allows the VCI device 128 to later decrypt the encrypted ECU public key 302E using its paired VCI private endorsement key 326. It is then the ability of the VCI device 128 to have access to the decrypted ECU public key 320D, that allows the vehicle ECU 124 to authorize a direct communication request from the VCI device 128 based on having access to the ECU private key associated with the decrypted ECU public key 320D.

Also, now that the diagnostic tool 202 has been able to know that the VCI device 128 is authorized, the diagnostic tool 202 can provide the secure access protocol 330 to the VCI device 128 so that it can use such to later formulate secure diagnostic requests to the vehicle ECU 124. In this regard, the diagnostic tool 202 will retrieve the previously stored and updated secure access protocol 330 (block 800.14 in FIG. 8B). The diagnostic tool 202 will communicate a request to the VCI device 128 to store the secure access protocol 330 (block 800.15 in FIG. 8B) for later use to formulate secure diagnostic requests to the vehicle ECU 124 using the secure access protocol 330 and the decrypted ECU public key 320D. In response, the VCI device 128 stores the secure access protocol 330 received from the diagnostic tool 202 (block 800.16 in FIG. 8B), and provides an acknowledgement response to the diagnostic tool 202 of a successful receipt and storage of the secure access protocol 330 (block 800.17 in FIG. 8B). The diagnostic tool 202 then sends a request to the VCI device 128 to save a diagnostic request that includes the VCI device identification 322 (block 800.18 in FIG. 8B), which is then saved by the VCI device 128 (block 800.19 in FIG. 8B) and acknowledged back to the diagnostic tool 202 (block 800.20 in FIG. 8B).

At this point, after performing the initialization processes 800A-800B in FIGS. 8A and 8B, an authorized VCI device 128 now has the necessary secure access protocol 330 and the ability to decrypt the ECU public key 320E to then formulate a secure communication request to the vehicle ECU 124 which can be authenticated based on the VCI device 128 having access to the decrypted ECU public key 320D.

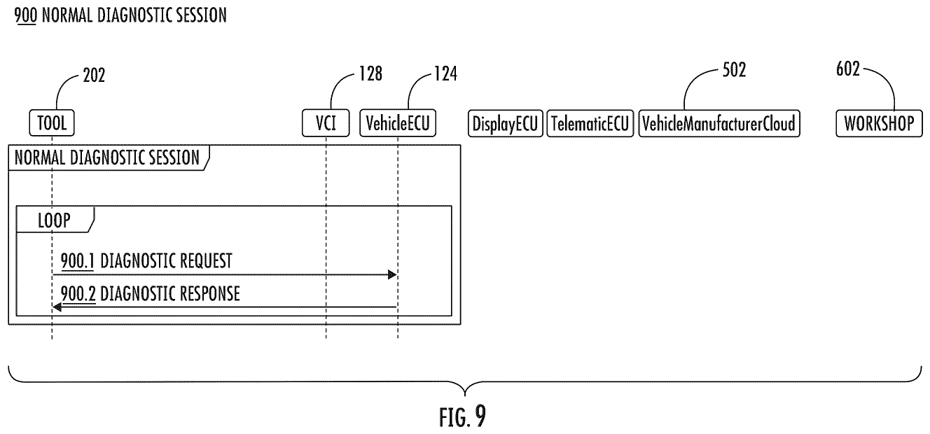

The diagnostic tool 202 can perform its normal diagnostic functions through communication to the vehicle ECU 124 using the connected VCI device 128 as an intermediate device. In this regard, FIG. 9 is an exemplary communication flow/process for a normal diagnostic session between the diagnostic tool 202 and the vehicle ECU 124 using the VCI device 128 as an intermediary device. As shown in FIG. 9, the diagnostic tool 202 can issue a diagnostic request to VCI device 128, which is then forwarded to the vehicle ECU 124 (block 900.1 in FIG. 9). The diagnostic tool 202 has access to the secure access protocol 330 to be able to send secure communication requests to the vehicle ECU 124, which can be authenticated by the vehicle ECU 124. The vehicle ECU 124 can provide responses back to the diagnostic tool 202 using the VCI device 128 as an intermediary device (block 900.2 in FIG. 9).

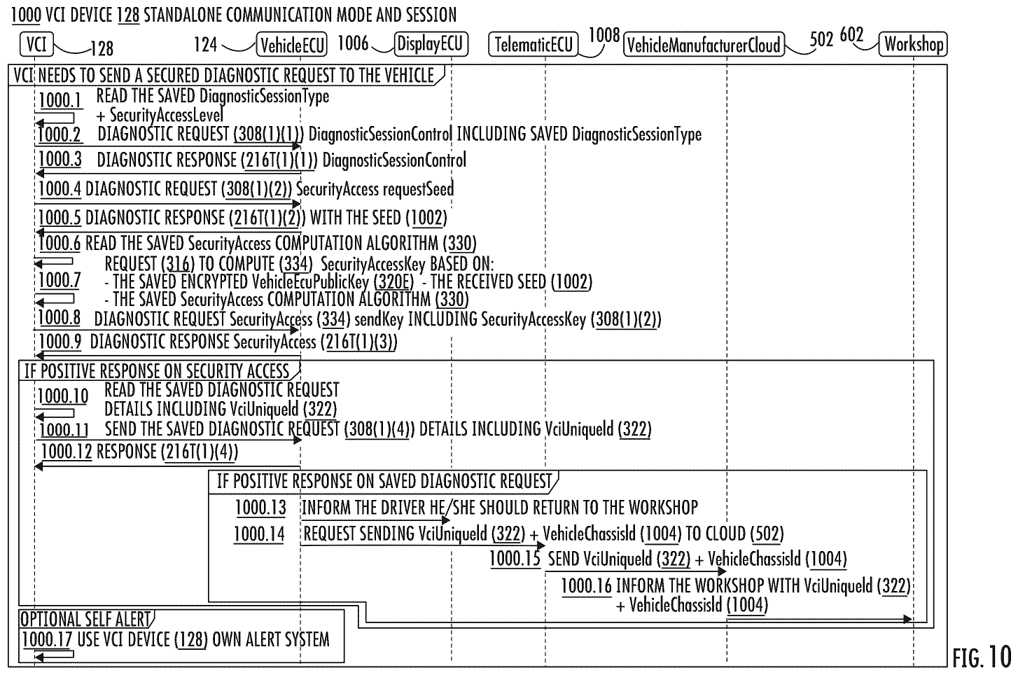

FIG. 10 is an exemplary communication flow/process of a VCI device 128 directly communicating requests (e.g., diagnostic requests) with a connected vehicle ECU 124, such that the vehicle ECU 124 can authorize the VCI device 128 and then provide responses to the VCI device 128 in response to such requests if authenticated. For example, the VCI device 128 may be configured to directly communicate diagnostic requests to the vehicle ECU 124 in response to and/or when the VCI device 128 connected to the vehicle 100 is no longer being connected to the diagnostic tool 202. In this regard, as shown in FIG. 10, in this example, when the VCI device 128 desires to send a direct diagnostic request 308(1) to a connected vehicle ECU 124 in a communication session, the VCI device 128 can read a saved diagnostic session type and security access level to be included in the diagnostic request (block 1000.1 in FIG. 10). This diagnostic request 308(1) can be a pre-defined diagnostic request, such as a loss prevention command. The VCI device 128 can then send a first diagnostic request 308(1)(1) for a diagnostic communication session to the vehicle ECU 124 based on the diagnostic session type (block 1000.2 in FIG. 10). In response, the vehicle ECU 124, not knowing if the first diagnostic request 308(1)(1) for a diagnostic communication session is from an authorized VCI device 128, will send a first security challenge 216T(1)(1) back to the VCI device 128 (block 1000.3 in FIG. 10). In response, in this example, the VCI device 128 will send another diagnostic request 308(1)(2) in this example for a seed 1002 to the vehicle ECU 124 (block 1000.4 in FIG. 10). The seed 1002 is a number or identifier that will be later used by the VCI device 128 to create a secure diagnostic request that can be authenticated by the vehicle ECU 124. This diagnostic request 308(1)(2) can also be a pre-defined diagnostic request, such as a loss prevention command. The vehicle ECU 124 sends the seed 1002 back to the VCI device 128 as part of a second security challenge response 216T(2) (block 1000.5 in FIG. 10).

With continuing reference to FIG. 10, the VCI device 128 will then access the secure access protocol 330 that is saved in memory (e.g., memory 304 in FIG. 3) (block 1000.6 in FIG. 10). The VCI device 128 will request the security circuit 316 to generate a security challenge response 334 based on a decrypted ECU public key 320E, the seed 1002, and the secure access protocol 330 (block 1000.7 in FIG. 10). As discussed above, to decrypt and protect the ECU public key 320D from exposure outside of the security circuit 316, the security circuit 316 will decrypt the ECU public key 320E using the VCI private endorsement key 326 accessible by the security circuit 316. The VCI device 128 will then send the security challenge response 334 as another diagnostic request 308(1)(3) to the vehicle ECU 124 (block 1000.8 in FIG. 10). The vehicle ECU 124 will then authenticate the security challenge response 334 and if valid, send another, second security challenge 216T(1)(3) back to the VCI device 128 indicating that the security challenge response 334 has been authenticated, meaning the VCI device 128 is authorized for the vehicle ECU 124 to service future direct diagnostic requests from the VCI device (block 1000.9 in FIG. 10). The vehicle ECU 124 is able to authenticate the security challenge response 334 using the vehicle ECU private key paired with the vehicle ECU public key 320D.

With continuing reference to FIG. 10, now that the vehicle ECU 124 has been able to authorize the VCI device 128 as being able to read its VCI device identification 322 from memory (e.g., memory 304) (block 1000.10 in FIG. 10), the VCI device 128 will send the desired diagnostic request 308(1)(4) that includes its VCI device identification 322 to the vehicle ECU 124 to be serviced (block 1000.11 in FIG. 10). The vehicle ECU 124 will determine if the diagnostic request 308(1)(4) is authorized based on determining if the VCI device identification 322 is associated with the prior communication session that authorized the VCI device 128 (block 1000.12 in FIG. 10). If the vehicle ECU 124 determines the diagnostic request 308(1)(4) is authorized, the vehicle ECU 124 will send a security challenge response 216T(1)(4) indicating the diagnostic request 308(1)(4) is authorized (block 1000.12 in FIG. 10). The vehicle ECU 124 will then handle the diagnostic request 308(1)(4) and respond as requested to the VCI device 128.

For example, if the diagnostic request 308(1)(4) is a VCI device loss prevention command to indicate an unconnected state of the diagnostic tool 202 to the VCI device 128, the vehicle ECU 124 can inform the driver that they should return to the vehicle workshop 602 to have the VCI device 128 removed from their vehicle 100 (block 1000.13 in FIG. 10). For example, the vehicle ECU 124 may be configured to display this message to the driver through a display 1006 in the vehicle 100. The vehicle ECU 124 can also send a communication message to a telematics system 1008 that can exchange communications with the vehicle 100 (e.g., such as through a radio or cellular communication system) of the VCI device identification 322 and its vehicle chassis identification 1004 of the vehicle 100 associated with the VCI device 128, to indicate the VCI device 128 has been left connected to the vehicle 100 (block 1000.14 in FIG. 10). The telematics system 1008 can then communicate the VCI device identification 322 and its vehicle chassis identification 1004 of the vehicle 100 to the authorized ECU agent 502 for example (block 1000.15 in FIG. 10), which can then report this information to the vehicle workshop 602 that the VCI device 128 has been left connected to the vehicle 100 (block 1000.16 in FIG. 10). As another option, the VCI device 128 could also generate its own alert to the driver of the vehicle 100 of the unconnected state, such as through a speaker or other noise generator or visual indicator (block 1000.17 in FIG. 10).

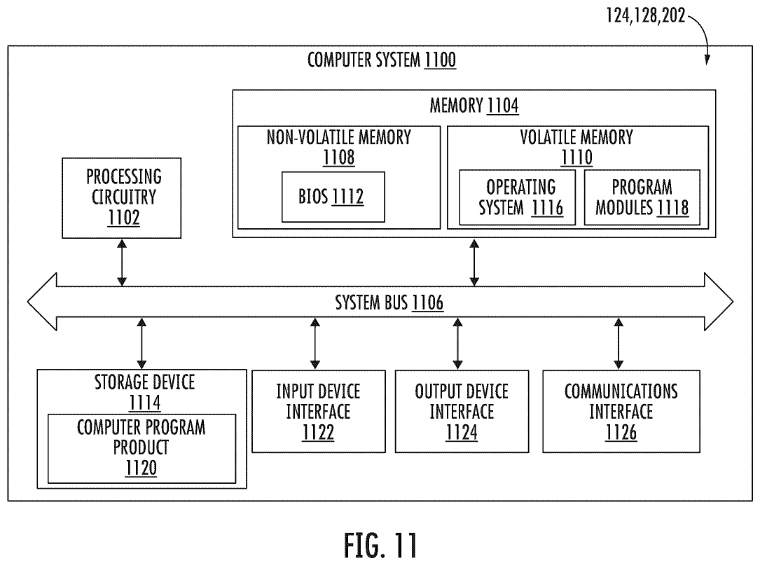

FIG. 11 is a block diagram of a computer system 1100 for implementing any examples disclosed herein. For example, the VCI device 128, the vehicle ECU 124, and/or the diagnostic tool 202 could each be provided by the computer system 1100 in FIG. 11. The computer system 1100 is adapted to execute instructions from a computer-readable medium to perform these and/or any of the functions or processing described herein. The computer system 1100 may be connected (e.g., networked) to other machines in a LAN, an intranet, an extranet, or the Internet. While only a single device is illustrated, the computer system 1100 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 1100 may comprise at least one computing device or electronic device capable of including firmware, hardware, and/or executing software instructions to implement the functionality described herein. The computer system 1100 may include processing circuitry 1102 (e.g., a processor including one or more processor devices or control units), a memory 1104, and a system bus 1106. The processing circuitry 1102 could be the processing circuitry 300 in FIG. 3, as an example, if the computer system 1100 was the VCI device 128. The computer system 1100 may include at least one computing device having the processing circuitry 1102. The system bus 1106 provides an interface for system components including, but not limited to, the memory 1104 and the processing circuitry 1102. The memory 1104 could be the memory 304 in FIG. 3 as an example, if the computer system 1100 was the VCI device 128. The processing circuitry 1102 may include any number of hardware components for conducting data or signal processing or for executing computer code stored in memory 1104. The processing circuitry 1102 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 1102 may further include computer executable code that controls operation of the programmable device.

The system bus 1106 may be any of several types of bus structures that may further interconnect to a memory bus (with or without a memory controller), a peripheral bus, and/or a local bus using any of a variety of bus architectures. The memory 1104 may be one or more devices for storing data and/or computer code for completing or facilitating methods described herein. The memory 1104 may include database components, object code components, script components, or other types of information structure for supporting the various activities herein. Any distributed or local memory device may be utilized with the systems and methods of this description. The memory 1104 may be communicably connected to the processing circuitry 1102 (e.g., via a circuit or any other wired, wireless, or network connection) and may include computer code for executing one or more processes described herein. The memory 1104 may include non-volatile memory 1108 (e.g., read-only memory (ROM), erasable programmable read-only memory (EPROM), electrically erasable programmable read-only memory (EEPROM), etc.), and volatile memory 1110 (e.g., random-access memory (RAM)), or any other medium which can be used to carry or store desired program code in the form of machine-executable instructions or data structures and which can be accessed by a computer or other machine with processing circuitry 1102. A basic input/output system (BIOS) 1112 may be stored in the non-volatile memory 1108 and can include the basic routines that help to transfer information between elements within the computer system 1100.

The computer system 1100 may further include or be coupled to a non-transitory computer-readable storage medium such as the storage device 1114, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 1114 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 1114 and/or in the volatile memory 1110, which may include an operating system 1116 and/or one or more program modules 1118. All or a portion of the examples disclosed herein may be implemented as a computer program 1120 stored on a transitory or non-transitory computer-usable or computer-readable storage medium (e.g., single medium or multiple media), such as the storage device 1114, which includes complex programming instructions (e.g., complex computer-readable program code) to cause the processing circuitry 1102 to carry out actions described herein. Thus, the computer-readable program code of the computer program 1120 can comprise software instructions for implementing the functionality of the examples described herein when executed by the processing circuitry 1102. In some examples, the storage device 1114 may be a computer program product (e.g., readable storage medium) storing the computer program 1120 thereon, where at least a portion of a computer program 1120 may be loadable (e.g., into a processor or processing circuitry) for implementing the functionality of the examples described herein when executed by the processing circuitry 1102. The processing circuitry 1102 may serve as a controller or control system for the computer system 1100 that is to implement the functionality described herein.

The computer system 1100 may include an input device interface 1122 configured to receive input and selections to be communicated to the computer system 1100 when executing instructions, such as from a keyboard, mouse, touch-sensitive surface, etc. Such input devices may be connected to the processing circuitry 1102 through the input device interface 1122 coupled to the system bus 1106 but can be connected through other interfaces, such as a parallel port, an Institute of Electrical and Electronic Engineers (IEEE) 1394 serial port, a Universal Serial Bus (USB) port, an IR interface, and the like. The computer system 1100 may include an output device interface 1124 configured to forward output, such as to a display, a video display unit (e.g., a liquid crystal display (LCD) or a cathode ray tube (CRT)). The computer system 1100 may include a communications interface 1126 suitable for communicating with a network as appropriate or desired. The communications interface 1126 could be the vehicle communication interface circuit 306 and/or the diagnostic tool communication interface circuit 314 in FIG. 3 as an example, if the computer system 1100 was the VCI device 128.

The operational actions described in any of the exemplary aspects herein are described to provide examples and discussion. The actions may be performed by hardware components, may be embodied in machine-executable instructions to cause a processor or processing circuitry to perform the actions, or may be performed by a combination of hardware and software. Although a specific order of method actions may be shown or described, the order of the actions may differ. In addition, two or more actions may be performed concurrently or with partial concurrence.

Implementation examples are described in the following numbered clauses:

Example 1: A vehicle communication interface (VCI) device, comprising:
a security circuit comprising a secure memory; and
a processing circuitry communicatively coupled to the security circuit;
the processing circuitry configured to:
   receive a secure access protocol and an encrypted electronic control unit (ECU) key from a diagnostic tool;
   send a diagnostic request to a vehicle ECU;
   receive a security challenge from the vehicle ECU in response to the diagnostic request; and
   in response to receiving the security challenge:
      request the security circuit to decrypt the encrypted ECU key into a decrypted ECU key and generate a security challenge response based on the decrypted ECU key and the secure access protocol; and
      send the security challenge response to the vehicle ECU.

Example 2: The VCI device of claim 1, wherein the security circuit is configured to:
decrypt the encrypted ECU key based on the encrypted ECU key; and
generate the security challenge response based on the decrypted ECU key and the secure access protocol.

Example 3: The VCI device of any of claims 1-2, wherein the processing circuitry is further configured to:
receive a second security challenge from the vehicle ECU in response to sending the security challenge response to the vehicle ECU; and
in response to the second security challenge indicating authorization of the VCI device:
   send a second diagnostic request based on the first diagnostic request to the vehicle ECU.

Example 4: The VCI device of any of claims 1-3, wherein the processing circuitry is further configured to:
detect if the diagnostic tool is not connected to the VCI device; and
in response to detecting the diagnostic tool not connected to the VCI device:
   send the diagnostic request to the vehicle ECU.

Example 5: The VCI device of claim 4, wherein the diagnostic request comprises a VCI device loss prevention command.

Example 6: The VCI device of any of claims 1-5, wherein the processing circuitry is further configured to:
receive a VCI device identification signature request from the diagnostic tool; and
in response to receiving the VCI device identification signature request, request the security circuit to sign a VCI device identification for the VCI device based on a VCI endorsement key.

Example 7: The VCI device of claim 6, wherein the VCI device identification comprises a unique serial number of the VCI device.

Example 8: The VCI device of any of claims 1-7, wherein the processing circuitry is further configured to:
receive a request from the diagnostic tool to store the encrypted ECU key; and
in response to receiving the request to store the encrypted ECU key, store the encrypted ECU key in a memory accessible by the processing circuitry.

Example 9: The VCI device of claim 8, wherein the processing circuitry is further configured to:
receive a request from the diagnostic tool to store the secure access protocol after receiving the request to store the encrypted ECU key; and
in response to receiving the request to store the secure access protocol, store the secure access protocol in the memory.

Example 10: The VCI device of any of claims 1-9, wherein the processing circuitry is configured to:
receive the security challenge comprising a seed from the vehicle ECU in response to sending the diagnostic request to the vehicle ECU; and
in response to receiving the security challenge, request the security circuit to generate the security challenge response based on the seed, the decrypted ECU key, and the secure access protocol.

Example 11: The VCI device of any of claims 1-10, wherein the processing circuitry is further configured to establish a communication session with the diagnostic tool connected to the VCI device;
the processing circuitry configured to receive the secure access protocol and the encrypted ECU key in the communication session.

Example 12: The VCI device of any of claims 1-11, further comprising a vehicle connector configured to be connected to a vehicle communication port communicatively coupled to the vehicle ECU;
wherein:
   the processing circuitry is communicatively coupled to the vehicle connector; and
   the processing circuitry is configured to:
      send the diagnostic request through the vehicle connector to the vehicle ECU;
      receive the security challenge through the vehicle connector from the vehicle ECU in response to the diagnostic request; and
      send the security challenge response through the vehicle connector to the vehicle ECU.

Example 13: A computer-implemented method of authorizing a vehicle communication interface (VCI) device with a vehicle electronic control unit (ECU) to allow for the VCI device to provide secure requests to the vehicle ECU, comprising the VCI device:
receiving a secure access protocol and an encrypted ECU key from a diagnostic tool;
sending a diagnostic request to the vehicle ECU;
receiving a security challenge from the vehicle ECU in response to the diagnostic request; and
in response to receiving the security challenge:
   decrypting the encrypted ECU key into a decrypted ECU key;
   generating a security challenge response based on the decrypted ECU key and the secure access protocol; and
   sending the security challenge response to the vehicle ECU.

Example 14: The method of claim 13, further comprising:
receiving a second security challenge from the vehicle ECU, in response to sending the security challenge response to the vehicle ECU; and
sending a second diagnostic request based on the first diagnostic request to the vehicle ECU, in response to the second security challenge indicating authorization of the VCI device.

Example 15: The method of any of claims 13-14, further comprising:
detecting if the diagnostic tool is not connected to the VCI device; and
in response to detecting the diagnostic tool not connected to the VCI device:
   sending the diagnostic request to the vehicle ECU.

Example 16: The method of any of claims 13-15, further comprising:
receiving a VCI device identification signature request from the diagnostic tool; and
signing a VCI device identification for the VCI device based on a VCI endorsement key, in response to receiving the VCI device identification signature request.

Example 17: The method of any of claims 13-16, wherein:
receiving the security challenge comprises receiving a seed from the vehicle ECU, in response to sending the diagnostic request to the vehicle ECU; and
generating the security challenge response based on the seed, the decrypted ECU key, and the secure access protocol, in response to receiving the first security challenge response.

Example 18: A computer program product comprising program code for performing, when executed by the processing circuitry, the method of any of claims 13-17.

Example 19: A non-transitory computer-readable storage medium comprising instructions, which when executed by the processing circuitry, causes the processing circuitry to perform the method of any of claims 13-17.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A vehicle communication interface (VCI) device, comprising:
a security circuit comprising a secure memory; and
a processing circuitry communicatively coupled to the security circuit;
the processing circuitry configured to:
receive a secure access protocol and an encrypted electronic control unit (ECU) key from a diagnostic tool;
send an unauthorized diagnostic request to a vehicle ECU;
receive a security challenge from the vehicle ECU in response to the unauthorized diagnostic request; and
in response to receiving the security challenge:
request the security circuit to decrypt the encrypted ECU key into a decrypted ECU key and generate a security challenge response based on the decrypted ECU key and the secure access protocol; and
send the security challenge response to the vehicle ECU.

2. The VCI device of claim 1, wherein the security circuit is configured to:
decrypt the encrypted ECU key based on the encrypted ECU key; and
generate the security challenge response based on the decrypted ECU key and the secure access protocol.

3. The VCI device of claim 1, wherein the processing circuitry is further configured to:
receive a second security challenge from the vehicle ECU in response to sending the security challenge response to the vehicle ECU; and
in response to the second security challenge indicating authorization of the VCI device:
send a second diagnostic request based on the first diagnostic request to the vehicle ECU.

4. The VCI device of claim 1, wherein the processing circuitry is further configured to:
detect if the diagnostic tool is not connected to the VCI device; and
in response to detecting the diagnostic tool not connected to the VCI device:
send the unauthorized diagnostic request to the vehicle ECU.

5. The VCI device of claim 4, wherein the diagnostic request comprises a VCI device loss prevention command.

6. The VCI device of claim 1, wherein the processing circuitry is further configured to:
receive a VCI device identification signature request from the diagnostic tool; and
in response to receiving the VCI device identification signature request, request the security circuit to sign a VCI device identification for the VCI device based on a VCI endorsement key.

7. The VCI device of claim 6, wherein the VCI device identification comprises a unique serial number of the VCI device.

8. The VCI device of claim 1, wherein the processing circuitry is further configured to:
receive a request from the diagnostic tool to store the encrypted ECU key; and
in response to receiving the request to store the encrypted ECU key, store the encrypted ECU key in a memory accessible by the processing circuitry.

9. The VCI device of claim 8, wherein the processing circuitry is further configured to:
receive a request from the diagnostic tool to store the secure access protocol after receiving the request to store the encrypted ECU key; and
in response to receiving the request to store the secure access protocol, store the secure access protocol in the memory.

10. The VCI device of claim 1, wherein the processing circuitry is configured to:
receive the security challenge comprising a seed from the vehicle ECU in response to sending the unauthorized diagnostic request to the vehicle ECU; and
in response to receiving the security challenge, request the security circuit to generate the security challenge response based on the seed, the decrypted ECU key, and the secure access protocol.

11. The VCI device of claim 1, wherein the processing circuitry is further configured to establish a communication session with the diagnostic tool connected to the VCI device;
the processing circuitry configured to receive the secure access protocol and the encrypted ECU key in the communication session.

12. The VCI device of claim 1, further comprising a vehicle connector configured to be connected to a vehicle communication port communicatively coupled to the vehicle ECU;
wherein:
the processing circuitry is communicatively coupled to the vehicle connector; and
the processing circuitry is configured to:
send the diagnostic request through the vehicle connector to the vehicle ECU;
receive the security challenge through the vehicle connector from the vehicle ECU in response to the diagnostic request; and
send the security challenge response through the vehicle connector to the vehicle ECU.

13. A computer-implemented method of authorizing a vehicle communication interface (VCI) device with a vehicle electronic control unit (ECU) to allow for the VCI device to provide secure requests to the vehicle ECU, comprising the VCI device:
receiving a secure access protocol and an encrypted ECU key from a diagnostic tool;
sending an unauthorized diagnostic request to the vehicle ECU;
receiving a security challenge from the vehicle ECU in response to the unauthorized diagnostic request; and
in response to receiving the security challenge:
decrypting the encrypted ECU key into a decrypted ECU key;
generating a security challenge response based on the decrypted ECU key and the secure access protocol; and
sending the security challenge response to the vehicle ECU.

14. The method of claim 13, further comprising:
receiving a second security challenge from the vehicle ECU, in response to sending the security challenge response to the vehicle ECU; and
sending a second diagnostic request based on the first diagnostic request to the vehicle ECU, in response to the second security challenge indicating authorization of the VCI device.

15. The method of claim 13, further comprising:
detecting if the diagnostic tool is not connected to the VCI device; and
in response to detecting the diagnostic tool not connected to the VCI device:
sending unauthorized the diagnostic request to the vehicle ECU.

16. The method of claim 13, further comprising:
receiving a VCI device identification signature request from the diagnostic tool; and
signing a VCI device identification for the VCI device based on a VCI endorsement key, in response to receiving the VCI device identification signature request.

17. The method of claim 13, wherein:
receiving the security challenge comprises receiving a seed from the vehicle ECU, in response to sending the unauthorized diagnostic request to the vehicle ECU; and
generating the security challenge response based on the seed, the decrypted ECU key, and the secure access protocol, in response to receiving the first security challenge response.

18. A computer program product comprising program code for performing, when executed by the processing circuitry, the method of claim 13.

19. A non-transitory computer-readable storage medium comprising instructions, which when executed by the processing circuitry, causes the processing circuitry to perform the method of claim 13.
